(19) United States
(12) Patent Application Publication
(10) Pub. No.: US 2010/0116160 A1
(43) Pub. Date: May 13, 2010

(54) Printing Unit With Imprinting Device And Printing Method

(75) Inventor: Sabine SIRACH, Augsburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: manroland AG, Offenbach am Main (DE)

(21) Appl. No.: 12/437,016

(22) Filed: May 7, 2009

(30) Foreign Application Priority Data
May 9, 2008 (DE) 10 2008 023 067.7

(51) Int. Cl. B41F 5/16; B41F 1/10

(52) U.S. Cl. 101/221; 101/490

(57) ABSTRACT

A printing unit (1, 2) in a web-fed rotary printing press for imprinting both sides of a printing stock web (7) with process colors cyan and/or magenta and/or yellow and/or black (CMYK), wherein at least one imprinting device (3) is arranged at the printing unit. The inking unit or inking units (9) of the imprinting device (3) is/are outfitted with an ink and/or an additive which are/is different than the process colors and which can be applied to the printing stock web (7).

### BACKGROUND OF THE INVENTION

1. Field of the Invention

The present invention is directed to a printing unit in a web-fed rotary printing press for imprinting both sides of a web of printing stock with one to four process colors cyan and/or magenta and/or yellow and/or black (CMYK), at least one imprinting device or offset imprinter being arranged at the printing unit.

2. Description of the Related Art

Double-sided four-color printing (4/4) is already possible in modern printing presses. Alternatively, the process colors CMYK (cyan [blue], magenta [purple], yellow, and key [black]) are printed on both sides using four blanket-to-blanket arrangements. In printing units with blanket-to-blanket arrangements, the corresponding inking units contain the four process colors.

The arrangement of the cylinder groups in bridge-type blanket-to-blanket arrangements has the disadvantage that fan out compensation must be integrated in wet offset methods for compensating fan out (expansion of the width of the paper web due to the application of dampening solution) before running into the second, third and fourth inter-blanket gap. For double-sided four-color printing, satellite printing units which are constructed, e.g., as 8-couple towers, are a suitable alternative to blanket-to-blanket arrangements.

Further, imprinting devices or offset imprinters are currently known. These imprinting devices were previously intended primarily for the use of alternating black imprinting. The imprinting devices can be retrofitted in existing printing presses or may be delivered already installed in new presses. They can be used in individual towers of a printing press or in all of the towers.

Some newspaper printing houses already print with special inks, for example, neon. But the existing inking units in the printing press, which normally print the process colors CMYK, must still be used for this purpose. Accordingly, combined printing of four colors plus a special ink is presently impossible.

### SUMMARY OF THE INVENTION

The inventor has recognized that imprinting devices or offset imprinters which are stacked or integrated in an existing 8-couple tower can be used to make possible a 6/4-, 5/4- or 5/5-color combination or for additional application of additives to the printing stock web. This opens up new possibilities for interesting press runs for publishing houses.

Therefore, it is an object of the present invention to provide a printing unit which is suitable for double-sided one- (1/1) to four- (4/4) color printing and by means of which additives or special inks can also be applied to the printing stock web.

Accordingly, the present invention proposes to improve a printing unit of a web-fed rotary printing press for imprinting both sides of a printing stock web with process colors cyan and/or magenta and/or yellow and/or black (CMYK), wherein at least one imprinting device or offset imprinter is arranged at the printing unit, in such a way that the inking unit or inking units of the imprinting device is/are outfitted with an ink and/or additive which are/is different than the process colors and which can be applied to the printing stock web.

In addition to a double-sided 1/1- to 4/4-color printing, this makes it possible to use striking special inks such as neon or additives on the printing stock web.

The printing unit can comprise at least two 9-cylinder satellite arrangements. The satellite printing unit is advantageously constructed as a 9-cylinder satellite arrangement. Accordingly, when two 9-cylinder satellite arrangements are arranged one above the other, a double-sided four-color printing (4/4) is made possible within a very compact space. Alternatively, the printing unit can be formed of at least two 10-cylinder satellite arrangements with two impression cylinders.

When compensating for the fan out effect in wet offset printing, four blanket-to-blanket arrangements can also ensure the 4/4-color printing.

The imprinting device can comprise one or two impression cylinders, wherein at least one printing location is formed with at least one transfer cylinder.

The inking unit or inking units of the imprinting device is/are advisably filled with lacquer and/or with additives composed at least partially of metal. A combination of four-color printing plus a special ink is made possible in this way.

The inking unit or inking units of the imprinting device or offset imprinter can be filled with pearlescent pigments. These are special effect pigments that produce a deep luster and uniform sheen on the surface of the printing stock. They are made of mica and refractive metal oxide coatings and afford unusual design possibilities. Scents such as perfumes or pheromones can also be used in the inking unit. In case of volatile materials, the inking unit is preferably constructed so as to be encapsulated. Alternatively or in addition, the scents can also be arranged in capsules so as to prevent premature evaporation and to ensure that these scents are emitted over a long period of time.

In order that printing presses with different print counts can be outfitted with the novel printing unit, the barrel or cylinder length of the impression cylinders, transfer cylinders and form cylinders corresponds to a length of two, four, six, eight, or ten vertical or horizontal newspaper pages.

Alternatively, the barrel or cylinder length of the impression cylinders, transfer cylinders and form cylinders can correspond to a length of three, five, seven, or nine vertical or horizontal newspaper pages.

In addition to the printing unit, the present invention also provides a method for imprinting a printing stock web in a web-fed rotary printing press, wherein the printing stock web is imprinted on both sides with one to four process colors cyan and/or magenta and/or yellow and/or black (CMYK), and wherein the printing stock web additionally runs through an imprinting device or offset imprinter. According to the invention, the inking unit or inking units of the imprinting device imprint(s) the printing stock web with an ink and/or an additive different than the process colors.

For example, the imprinting device can apply lacquer and/or additives composed at least partially of metal first to the form cylinders, then to the transfer cylinders and, finally, to the printing stock web.

Alternatively or in addition to this, the imprinting device can apply pearlescent pigments and/or scents first to the form cylinders, then to the transfer cylinders and, finally, to the printing stock web.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

Preferred embodiments of the present invention are described more fully with reference to the drawings in which:

FIG. 1 shows two satellite printing units with an imprinting device for 5/4 color printing;

FIG. 2 shows two satellite printing units with an imprinting device for 5/5 color printing;

FIG. 3 shows two satellite printing units with an imprinting device for 6/4 color printing; and

FIG. 4 shows two 10-cylinder satellite printing units with two impression cylinders and an additional imprinting device.

### DETAILED DESCRIPTION OF THE PRESENTLY PREFERRED EMBODIMENTS

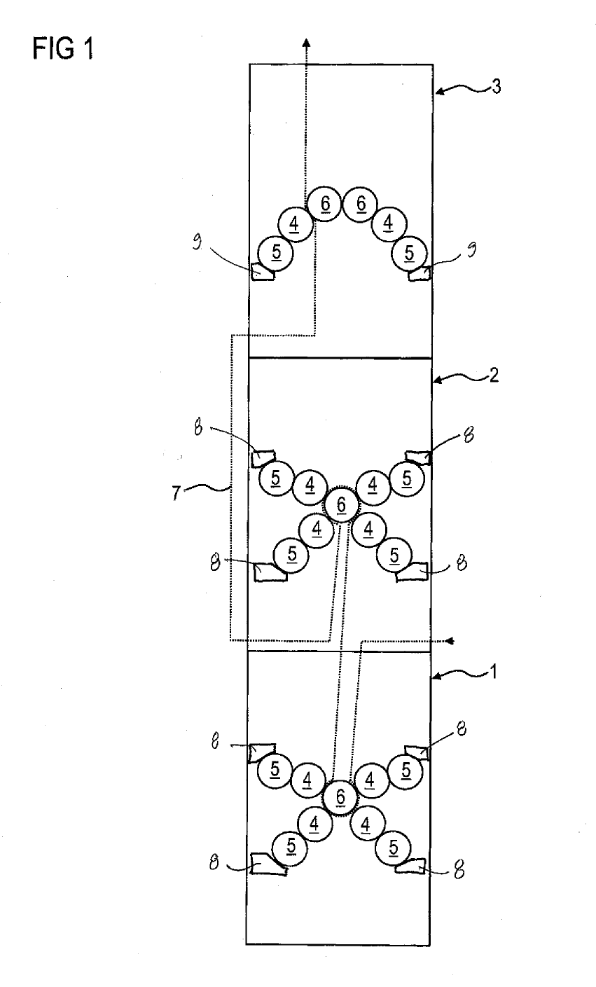

FIG. 1 shows two satellite printing units 1 and 2 with an imprinting device or offset imprinter 3 for 5/4 color printing. Accordingly, the printing stock web to be imprinted is imprinted with five colors on the first side of the printing stock web and with four colors on the second side of the printing stock web.

The printing stock web 7, generally paper, is first fed to the first satellite printing unit 1. The printing stock web 7 loops around the impression cylinder 6 of the first satellite printing unit 1 and is provided with ink by the four transfer cylinders 4 contacting the impression cylinder 6.

When the four printing locations are supplied with different inks, one side of the printing stock web is imprinted with four colors. The color(s) is/are transferred by inking units 8, only shown in FIG. 1, first to the form cylinders 5, which carry one or more printing plates or sleeves, and from the latter to the printing stock web 7 by the transfer cylinders 4.

After the first side of the printing stock web 7 is printed, the printing stock web 7 is fed to the second satellite printing unit 2, and the other side of the printing stock web 7 is imprinted in analogous manner with one or up to four colors.

An imprinting device or offset imprinter 3 is arranged above the two printing units 1 and 2 constructed as 9-cylinder satellites. The imprinting device 3 in this construction comprises two impression cylinders 6, and a transfer cylinder 4 and form cylinder 5 which contact the two impression cylinders 6 so that a total of two printing locations is formed. In FIG. 1, the printing stock web 7 which is imprinted on both sides in the printing units 1 and 2 is fed to the left-hand printing location in the imprinting device 3 so that one side of the printing stock web 7 can be imprinted with an additional ink from inking unit 9 (only shown in FIG. 1) and a 5/4 color printing is accordingly possible.

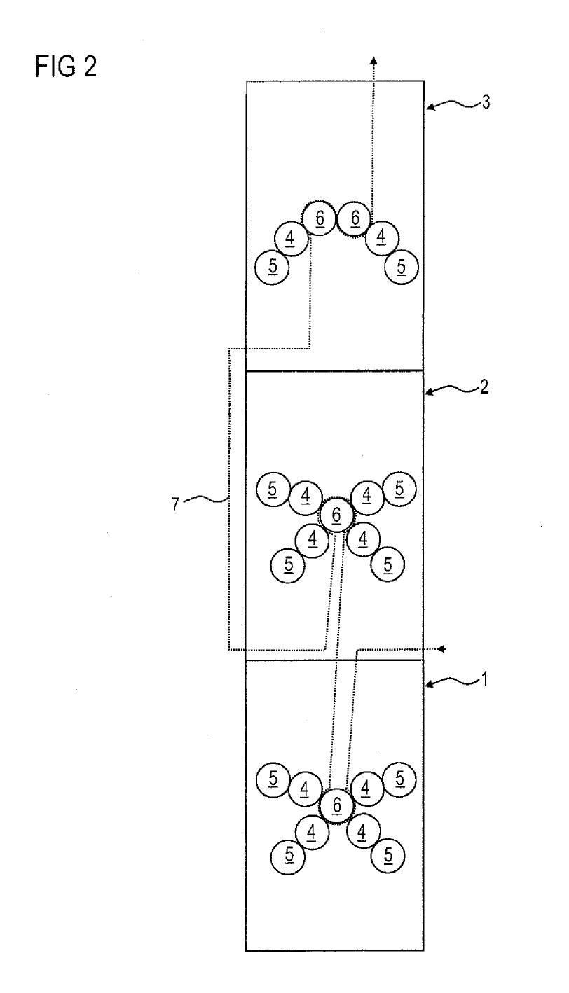

FIG. 2 shows two satellite printing units 1 and 2 with an imprinting device 3 for 5/5 color printing. The construction corresponds to that shown in FIG. 1. The double-sided printing of the printing stock web 7 by means of the two 9-cylinder satellite printing units 1 and 2 is carried out in a manner analogous to FIG. 1.

However, the guiding of the printing stock web 7 in the imprinting device 3 differs from that in FIG. 1. As in FIG. 1, the printing stock web 7 is initially imprinted by the left-hand printing location of the imprinting device 3. The printing stock web 7 loops around the two impression cylinders 6 of the imprinting device 3 in an S-shaped manner and is finally also imprinted on the other side by the second printing location so that a 5/5 color printing is possible.

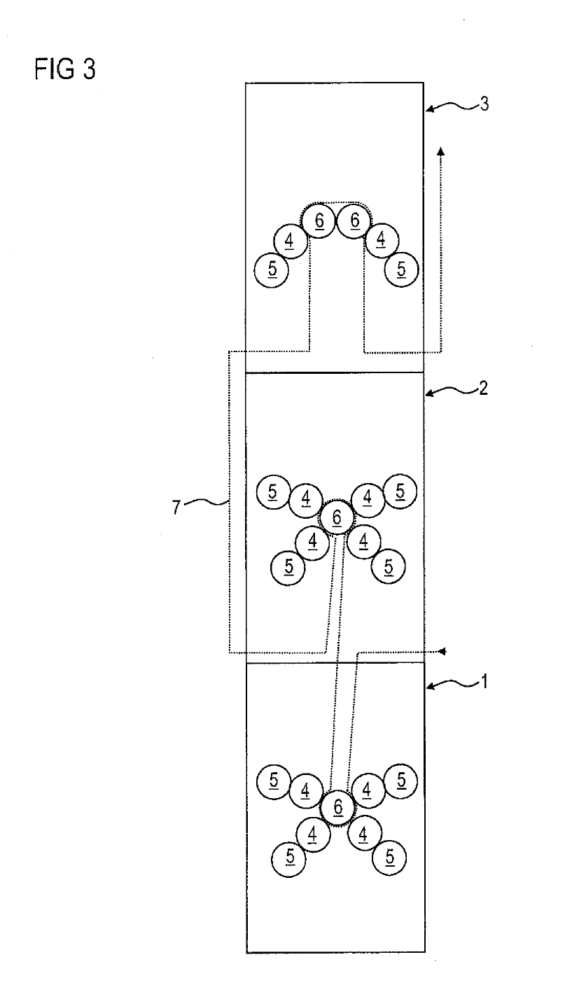

FIG. 3 shows another guiding of the web in a printing unit construction that is identical in other respects and which makes possible a 6/4 color printing.

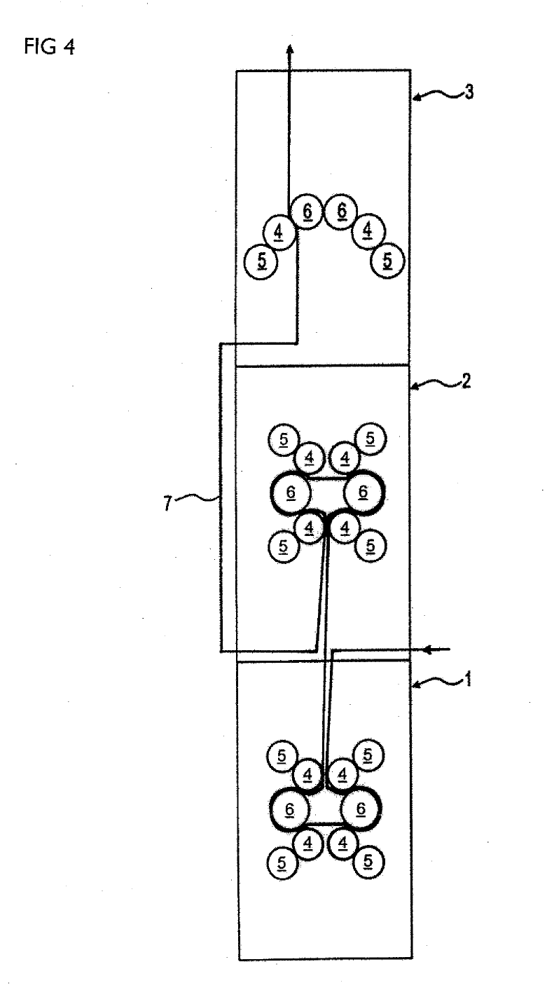

FIG. 4 shows a printing unit which is similar to that of FIG. 1, except that it has two-cylinder satellite printing units 1 and 2 and a downstream imprinting device or offset imprinter 3 for 5/4 color printing.

It is expressly noted that the inking units 9 of the imprinting device need not necessarily contain only an (special) ink because a 4/4 color printing is already made possible by the printing units 1 and 2. Rather, the inking units 9 can also contain additives such as scents or particles such as sand, mica, etc. which achieve a tactile or haptic effect on the printing stock web.

The invention is not limited by the embodiments described above which are presented as examples only but can be modified in various ways within the scope of protection defined by the appended patent claims.

I claim:

1. A printing unit in a web-fed rotary printing press for imprinting both sides of a printing stock web with process colors selected from one or more of cyan, magenta, yellow and black, said printing unit comprising at least one imprinting device (3) comprising an inking unit (9) arranged at said printing unit, said inking unit of said imprinting device (3) being outfitted with one of an ink and an additive which is different than said process colors and which can be applied to said printing stock web (7).

2. The printing unit according to claim 1, comprising at least two 9-cylinder satellite arrangements.

3. The printing unit according to claim 1, comprising at least two 10-cylinder satellite arrangements with two impression cylinders (6).

4. The printing unit according to claim 1, comprising at least four blanket-to-blanket arrangements.

5. The printing unit according to claim 1, comprising at least one printing location and at least one transfer cylinder, and wherein said imprinting device (3) comprises one of one and two impression cylinders (6); and wherein said at least one printing location is formed with said at least one transfer cylinder (4).

6. The printing unit according to claim 1, wherein said inking unit of said imprinting device (3) is filled with one of lacquer and a metal containing additive.

7. The printing unit according to claim 1, wherein said inking unit of said imprinting device (3) is filled with one of pearlescent pigments and scents.

8. The printing unit according to claim 1, comprising impression cylinders (6), transfer cylinder (4) and form cylinders (5), said impression cylinders, transfer cylinders and form cylinders having a cylinder length and wherein said cylinder length of said impression cylinders (6), transfer cylinders (4) and form cylinders (5) of said printing unit corresponds to a length of one of two, four, six, eight, and ten vertical or horizontal newspaper pages.

9. A method for imprinting a printing stock web (7) in a web-fed rotary printing press, comprising
imprinting the printing stock web (7) on both sides with one or more process colors selected from one or more of cyan, magenta, yellow and black;
running the printing stock web (7) through an imprinting device (3); and
imprinting the printing stock web (7) by the inking unit of the imprinting device (3) with one of an ink and an additive which is different from the process colors.

10. The method according to claim 9, wherein the inking unit of the imprinting device (3) applies one of lacquer and a metal containing additives to the printing stock web (7).

11. The method according to claim 9, wherein the inking unit of the imprinting device (3) applies one of pearlescent pigments and scents to the printing stock web (7).

12. The method according to claim 10, wherein the inking unit of the imprinting device (3) applies one of pearlescent pigments and scents to the printing stock web (7).
